(19) United States
(12) Patent Application Publication
(10) Pub. No.: US 2008/0162119 A1
(43) Pub. Date: Jul. 3, 2008

(54) Discourse Non-Speech Sound Identification and Elimination

(76) Inventor: Martin L. Lenhardt, Hayes, VA (US)

Correspondence Address: HUNTON & WILLIAMS/NEW YORK;INTELLECTUAL PROPERTY DEPT., 1900 K STREET, N.W., SUITE 1200, WASHINGTON, DC, 20006-1109, US

(21) Appl. No.: 11/968,915

(22) Filed: Jan. 3, 2008

Related U.S. Application Data
(60) Provisional application No. 60/878,210, filed on Jan. 3, 2007.

(51) Int. Cl. G10L 19/02

(52) U.S. Cl. 704/200.1; 704/500; 704/E19.014

(57) ABSTRACT

An acoustic signal is subjected to filtration whereby low frequency sounds such as respiration are removed. Intense acoustic sounds such as coughing are also removed, and ultrasonic carrier modulation and demodulation is also performed to increase the saliency of speech sounds. By removing non-speech sounds from an acoustic signal comprising speech, a method is disclosed for improving the functioning of devices such as speech recognition machinery. Devices for implementing such techniques are also disclosed.

### CROSS-REFERENCE TO RELATED APPLICATIONS

This application claims the benefit of provisional patent application No. 60/878,210 entitled “DISCOURSE NON-SPEECH SOUND IDENTIFICATION AND ELIMINATION” by Martin Louis Lenhardt filed Jan. 3, 2007, the entirety of which is incorporated by reference.

### BACKGROUND OF THE INVENTION

### Field of Invention

The present invention relates to a method for removing non-speech and non-language speech sounds from a signal.

### BACKGROUND OF THE INVENTION

Human non-speech sounds [NSS] (laughter, coughing, grunting, sighing, breathing, clicking) and non-language speech sounds [NLSS] (“mhm”, “hmm”, “unhuh”, etc.) can cause notable problems for transcription devices and like automatic speech processing devices. In particular, devices that act to recognize speech, language, and speaker identity may have difficulty in correctly processing such speech signals and information because of the presence of NSS and NLSS.

NSS and NLSS can be considered human noise; however, this “noise” has human periodicity since the source is also the human vocal tract. Accordingly, there is a present need for a device which will attenuate or eliminate NSS and NSLL signals, at least in part, by utilizing the periodicity of human NSS and NSLL signals.

The present invention solves at least one or more of the problems and needs described in this application, including:
the ability to identify and classify NSS and NLSS.
automatically remove NSS and NLSS using novel speech processing algorithms to the speech sample before, during, and after modulation with a peak-clipped carrier.
algorithms capable of multiple channel conditions and speakers.

### REFERENCES

The following references describe speech processing algorithms and are hereby incorporated by reference thereto:
Barlow, A. R. (1993). Language-Specific and Universal Aspects of Vowel Production and Perception: A Cross-Linguistic Study of Vowel Inventories. Ithaca, N.Y.: CLC Publications.
Gandour J, Xu Y, Wong D, Dzemidzic M, Lowe M, Li X, Tong Y. Neural correlates of segmental and tonal information in speech perception. Hum Brain Mapp. December; 20(4): 185-200, 2003
Glas J. R. A probabilistic framework for segment-based speech recognition. Computer Speech and Language, 17, 137-152, 2003
Gregory, R. L., Drysdale A. E. Squeezing speech in the deaf ear. Nature, 264, 748-751, 1976
Hayes, D. Transient impulse control for hearing aids, Hearing Review, 13, 13; 56-59, 2006
Jakobson, R. (1995). On Language. Ed. L. R. Waugh & M. Monville-Burston. Cambridge, Mass.: Harvard Free Press.
Kates J M, Weiss M R. A comparison of hearing-aid array-processing techniques. J Acoust Soc Am; 99:3138-48, 1996.
Kates J M. Speech enhancement based on a sinusoidal model. J Speech Hear Res 37(2):449-64, 1994
Kornai, A. (1999). Extended Finite State Models of Language. Cambridge: Cambridge UP.
Lenhardt, M. L., Skellett, R, Wang, P, Clarke, A. M. Human ultrasonic Speech Perception. Science, 252, 82-85, 1991
McAulay R J, Quatieri T F. Speech analysis/synthesis based on a sinusoidal representation. IEEE Trans Acoust Speech; 34(4):744-54, 1986

### SUMMARY OF THE INVENTION

The present invention is, in one or more embodiments, a method for the removal and/or attenuation of non-speech and non-language speech sounds from a signal, said method comprising the steps of generating a carrier signal in the ultrasonic bandwidth; receiving said signal and filtering said signal, wherein said filtration includes filtering low-frequency signals and temporal filtration; modulating said signal with said carrier signal wherein the modulation produces a peak-clipped signal; filtering said peak-clipped signal; demodulating said peak-clipped signal; and filtering the demodulated peak-clipped signal.

The present invention is also, in one or more embodiments, a method of removing or attenuating non-speech and/or non-language speech sounds using the embodiments of the above device comprising the steps of providing said signal comprising an audio waveform having at least one non-speech or non-language speech sounds; providing said carrier signal; optionally amplifying the signal and/or the carrier signal; filtering the signal non-temporally to provide a non-temporally filtered signal; filtering the signal temporally to provide a non-temporally and temporally filtered signal; modulating the signal onto the carrier signal to produce a modulated signal; peak clipping the modulated signal; optionally filtering the modulated signal; demodulating the modulated signal to produce a demodulated signal thereby producing a final signal; and optionally amplifying and/or filtering the demodulated signal to produce an additionally processed final signal. The modulator (multiplier) may be adapted to produce full amplitude modulation containing a carrier and two sidebands.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow chart showing one embodiment of the present invention in which various elements are chained to produce NSS and/or NLSS free sound.

FIG. 2 is a flow chart showing one embodiment of the present invention showing a method of removing NSS and/or NLSS sound.

FIG. 3 shows an example of the results of ultrasonic modulation/demodulation of a signal and is prior art.

FIG. 4 is a block-schematic of one embodiment of the present device in which the method is described.

### BRIEF DESCRIPTION OF REFERENCE NUMERALS

Oscillator; 104 Amplifier; 106 Microphone or Other Signal Input comprising a Signal; 108 Filter; 110 Multiplier/Modulator; 112 Mixer; 114 Output; 202 Speech Signal; 204 Digital Filtering (Filtration); 206 Temporal Filter (Temporal Filtration) & Vocalic Detector (Vocalic Detection); 208 Modulation; 210 De-modulation; 212 Fine-Tuning (Additional Processing, e.g., Amplitude Adjustment); 214 Linguistic Signal (Enhanced Speech Signal); 216 To Output; 300 Un-modulated signal; 302 Modulated/Clipped Signal; 304 Demodulated Signal.

### DEFINITIONS

Certain terms of art are used in the specification that are to be accorded their generally accepted meaning within the relevant art; however, in instances where a specific definition is provided, the specific definition shall control. Any ambiguity is to be resolved in a manner that is consistent and least restrictive with the scope of the invention. No unnecessary limitations are to be construed into the terms beyond those that are explicitly defined. Defined terms that do not appear elsewhere provide background. The following terms are hereby defined:

AUTOMATIC SPEECH PROCESSING DEVICES: Devices that interpret, recognize, and identify speech and which may comprise the pre-processing stage of audio speech analysis.

CARRIER or CARRIER WAVE: A waveform suitable for modulation by an information-bearing signal; a waveform (usually sinusoidal) that is modulated (modified as by signal multiplication) with an input signal for the purpose of conveying information, for example voice or data, to be transmitted. This carrier wave is usually of much higher frequency than the baseband modulating signal (the signal which contains the information).

SIDEBAND: A sideband is a band of frequencies higher than or lower than the carrier frequency, containing power as a result of the modulation process. The sidebands consist of all the Fourier components of the modulated signal except the carrier. All forms of modulation produce sidebands. Amplitude modulation of a carrier wave normally results in two mirror-image sidebands. The signal components above the carrier frequency constitute the upper sideband (USB) and those below the carrier frequency constitute the lower sideband (LSB). In conventional AM transmission, the carrier and both sidebands are present, sometimes called double sideband amplitude modulation (DSB-AM).

FILTER: An electrical device used to affect certain parts of the spectrum of a sound, generally by causing the attenuation of bands of certain frequencies. In the present invention, a filter may comprise, without limit: high-pass filters (which attenuate low frequencies below the cut-off frequency); low-pass filters (which attenuate high frequencies above the cut-off frequency); band-pass filters (which combine both high-pass and low-pass functions); band-reject filters (which perform the opposite function of the band-pass type); octave, half-octave, third-octave, tenth-octave filters (which pass a controllable amount of the spectrum in each band); shelving filters (which boost or attenuate all frequencies above or below the shelf point); resonant or formant filters (with variable centre frequency and Q). A group of such filters may be interconnected to form a filter bank. In embodiments of the present invention, where more than one filter may be used to properly adjust the characteristics of a signal, a filter may be a single filter, a group of filters, and/or a filter bank.

VOCALIC DETECTOR: Means for detecting vowel like sounds.

TEMPORAL FILTRATION: Temporal filtration is a means of removing or selecting temporal information in speech, wherein temporal information subsists of frequency bands containing amplitude fluctuations. For example, envelope fluctuations are understood to exist primarily below 50 Hz; periodicity (voicing) fluctuations occur between approximately 50 and 500 Hertz; and fine structure fluctuations exists above these rates. Temporal filtration may include low pass filtering, also known as smoothing, of a rectified speech signal.

TIMBRE: The distinguishable characteristics of a tone as mainly determined by the harmonic content of a sound and the dynamic characteristics of the sound. Dynamic characteristics of sound include a sound's vibrato and the attack-decay envelope of a sound.

VOCAL FORMANTS: Frequency ranges where the harmonics of vowel sounds are enhanced. It may also be a peak in the harmonic spectrum of a complex sound arising from the resonance of a source. Formants add comprehensibility to speech.

VIBRATO: Periodic changes in the pitch of a tone; FM like.

TREMOLO: Periodic changes in the amplitude or loudness of tone; AM like.

PITCH: The frequency of a sound wave.

PHONATION: The process of converting the air pressure from the lungs into audible vibrations.

SIGNAL SATURATION: The point at which an amplifier produces no increase in output signal with increasing input signal.

### DETAILED DESCRIPTION OF THE INVENTION

The present invention will automatically remove NSS and NLSS using novel speech processing algorithms and modulation. For example, the invention may, in one or more embodiments, comprise the steps of bandpass filtering followed by temporal and vocalic identification algorithms (applied one or more times, preferably three times, i.e., first on the filtered speech, secondly on the speech after amplitude modulation with carrier peak clipping and thirdly after demodulation). These algorithms extract sound that is not vocalic and/or does not adhere to grouping based on breath support for speech. Applying these speech algorithms before, during, and after modulation is an innovation that allows extraction of non-speech sounds and improves detection of relatively weaker high frequency consonants. This approach capitalizes on current speech segmentation and extends it for efficient non-speech extraction. Additionally “near non-audible speech sounds” will become more salient as a result of the modulation process.

This approach eliminates the need for hand-labeling of NLSS and automatically identifies and eliminates non-language speech sounds at a pre-processing stage to improve later audio processing. These algorithms accommodate multiple channel conditions and speakers. The application of this technology for improved efficiency is immediate in automatic speech processing, especially in security venues where rapid accurate processing is critical.

Selecting speech from noise is typically accomplished by identifying the periodicity of human vocal fold acoustics. NSS and NLSS can be considered human noise; however, this “noise” has human periodicity since the source is also the human vocal tract. There is a linguistic purpose for some NLSS, and in that strict sense it is not non-linguistic. Speakers often use non-informational elements to “hold the floor”, thus these utterances have pragmatic linguistic importance and will always appear in discourse. For automatic processing, pragmatic constraints are not a concern; however, such utterances do often prevent one speaker “talking over” another, and hence still has value in maintaining intelligibility.

In one embodiment of the present invention, digital signal processing (DSP) techniques of filtering and temporal processing are used to segment some NSS and NLSS sounds. Additionally, a novel ultrasonic modulation technique works to further resolve others. The approach may be based on a classification scheme that parses speech sounds into the following: vegetative sounds, vocalic sounds, and non-linguistic (articulatory) speech sounds.

Vegetative sounds are breathing related acoustics, such as respiratory sounds, coughing, grunting, sighing and clicking. All have strong low frequency components that often mask articulatory sounds in speech. Band pass filtering from 400 to 10,000 Hz can eliminate the strongest energy components of these sounds. The lower frequency (and the slope of the filter) may be modified but are preferably in the range of 400 Hz. Coughs and grunts produce strong resonances in the vocal tract.

Vocalic sounds are characterized by phonation, i.e. vocal fold vibration. All vowels and diphthongs are vocalic. The fundamental frequency (number of times the vocal folds vibrate) produces resonances in the vocal tract. These resonances are termed formants. Formants can be steady state or rise or fall in frequency. Sounds that are vocalic are speech sound, but may be non-linguistic in the case of “ah”, “mm”, etc. Formant transitions are shifts in frequency in the context of consonants. The presence of formant transitions would be characteristic of speech sounds and, as such, will be coded by detection algorithms. Other sounds are higher in frequency, as sibilants and fricatives and the absence of low frequency energy would be an additional speech characteristic.

Non-linguistic (articulatory) speech sounds are sounds that could be used linguistically, as in a phrase but are not. Prolonging an initial sound in a word is an example of a NLSS that is human speech noise to be eliminated. Other examples are isolated speech sounds produced during the speech act, but are non-informative, e.g., “mm”. NLSS are often temporally displaced in discourse. Intentional speech (speech with a purpose) has timing, passed on breath support called a phrase group. The flow of speech sounds in words is paced precisely by the brain and is based on breath support. NLSS differ in temporal pattern and may be isolated by their time characteristic to be determined in this proposal.

To recap, this invention incorporates algorithms to identify and eliminate NSS and NLSS prior to the pre-processing stage of audio speech analysis. NSS and/or NSLL signals may be resolved and removed utilizing a combination of techniques that act together to provide a dramatically improved audio signal, i.e. an audio signal with significantly less NSS and/or NSLL signals. The combination relies on 1) digital signal processing (DSP) techniques of filtration and temporal processing to segment at least some NSS and/or NSLL sounds; and 2) a ultrasonic modulation technique to further resolve additional NSS and/or NSLL sounds.

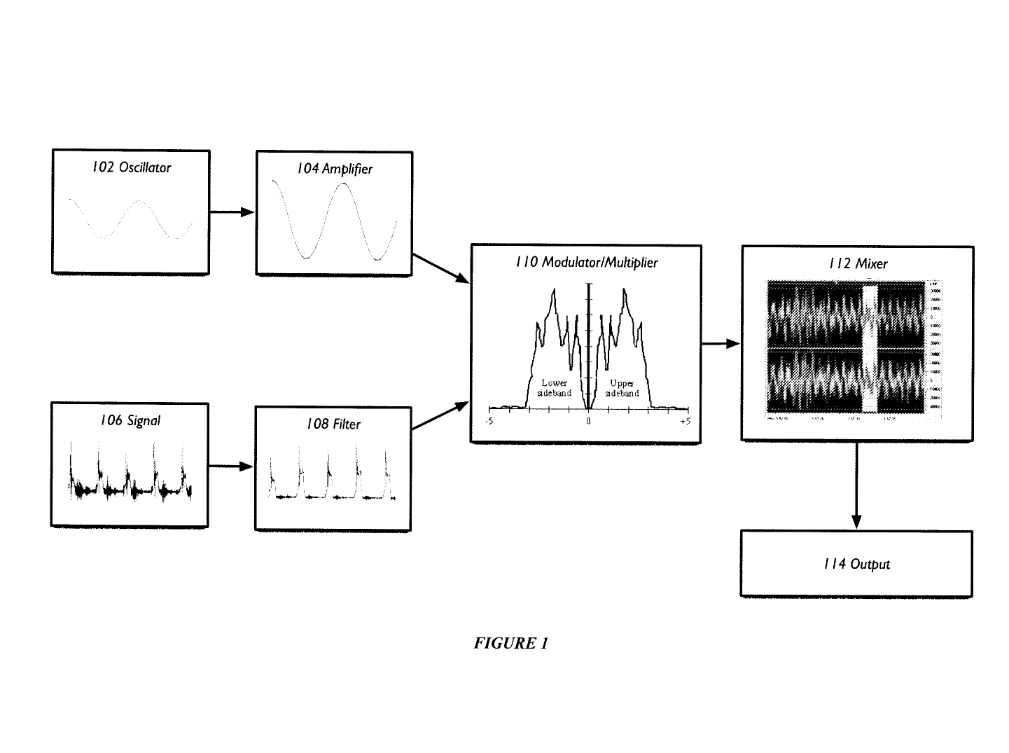

A series of processing algorithms that filter, provide spectral analysis, frequency tracking, and other signal modification means convey significant features of speech such as envelope, fundamental frequency, and formants. In one embodiment, a sound engine with at least one DSP board is adapted with software specialized for speech processing. The board is thereby adapted to provide filtration, time/frequency/amplitude compression and expansion, real-time analysis, and resynthesis. Algorithms may be programmed in a number of languages including C and cognate programming languages such as C++ and downloaded to the DSP board(s). A DSP board may be configured to comprise the elemental functionality of the schematized device of FIG. 1.

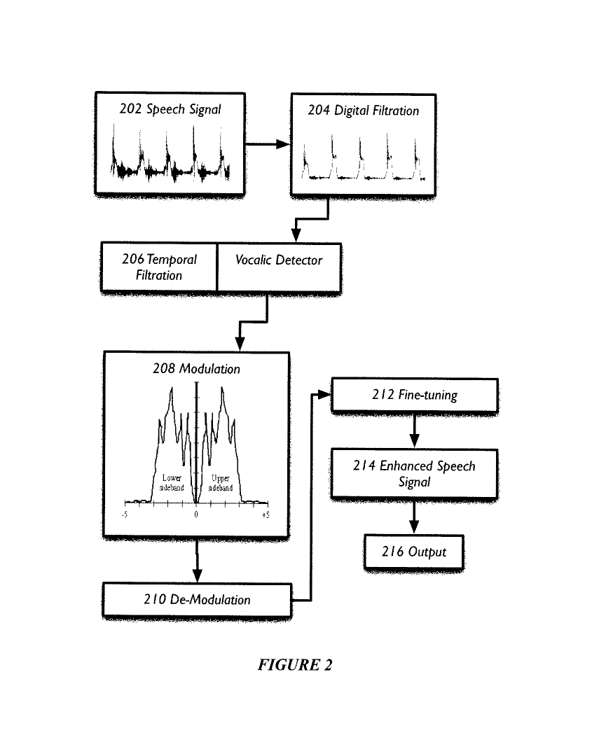

Turning to FIG. 2, it can be seen that in one embodiment, the system consists of an initial filter 204. Such a filter may be adapted to adjustably remove lung and respiratory sounds in a speech signal 202. An additional temporal filter, used in conjunction with a vocalic detector 206 may be adapted to utilize algorithms that identify vocal fold activity (phonation) and measure the duration of an utterance (breath grouping). Some such non-speech sounds may be removed at this point. To reduce the amplitude of intense sounds such as coughs and to increase the relative amplitude of high frequency consonants, the speech sample may then be modulated on an ultrasonic carrier 208. The carrier frequency and intensity is adjustable as is the percent of modulation. The signal comprised on the carrier can then be driven into saturation (peak clipping, not shown in FIG. 2). The temporal and vocalic algorithms may then be applied again to remove any additional non-speech sounds that exhibit abnormal, i.e. atypical for speech discourse, characteristics (not shown in FIG. 2). The speech sample is next demodulated 210 using diode rectification. The result is enhanced consonant energy allowing more precise identification. The signal 212 now comprises a signal in which most NLSS have been removed providing an output comprising an enhanced linguistic signal 214. The speech sample is now ready for further (automatic) processing 216, such as by speech recognition software.

The invention, in one or more embodiments, may comprise the following elements. Reference is to be had with FIGS. 1 and 2. It is to be noted that the following elements are exemplary means for using the methods of the present invention.
a. A source 102 providing an oscillator for carrier modulation in an ultrasonic bandwidth of 20-100 kilohertz (kHz). Some variation above and below this bandwidth is contemplated;
b. A microphone or other input line 106 adapted to carry an audio signal (whether analog or digital). A direct line-in can also be used for recorded materials or for other sourced audio signals;
c. At least one amplifier 104 to provide a means for amplifying the audio signal and/or carrier signal. The signal may be amplified prior to further automatic speech processing by an amplifier 212.
d. At least one filter 108/204 adapted to remove low frequency signals (<400 Hertz) in order to attenuate lung and respiratory sounds as well as to reduce intense audio spikes and acoustic energy from cough sounds.
e. At least one temporal filter and vocalic detector 206. These filters 206 comprise a series of filtering and processing algorithms adapted to identify the temporal qualities of speech as well as the presence of vocal fold (phonation) vibrations.
f. At least one modulator 208 and/or at least one multiplier 110 with ultrasonic carrier. An ultrasonic peaked, clipped carrier may multiply with a speech signal using multiplier 108. The result is a reduction in intense non-speech sounds with improved saliency of acoustic markers relative to other non-speech sounds. The multiplier may be adapted via algorithm to produce full AM (carrier and 2 sidebands).
g. At least one demodulator 210 such as a diode rectifier. The demodulator is adapted to restore the speech sample while increasing the amplitude of consonant sounds, allowing improved speech saliency.

The oscillator 102, which produces an ultrasonic acoustic signal for modulation with another signal, may be any device capable of producing an ultrasonic signal, such as, in an exemplary embodiment, a frequency generator. The ultrasonic acoustic signal may be set at predetermined frequency such as on the order of 25 kHz, but the ultrasonic frequency can be any desired ultrasonic frequency including frequencies on the order of 30 kHz or other inaudible ultrasonic carrier frequencies below or above this value.

The device also includes means for modulating the ultrasonic signal with an audio signal from an audio source to produce a modulated ultrasonic signal at an output, such as, for example, an amplitude modulated signal. Any of the acoustic signals generated by the device or received into the device may be amplified either by the modulation means or by a separately attached amplifier.

The invention may, in one or more embodiments, comprise any of the above elements, which may further be interconnected in the following manner:
a. A speech signal is provided from an input source such as a microphone or direct line-in. The speech signal is filtered to remove chest, lung, and respiratory sounds 204 by a filter such as 108 to produce a processed signal. This processed signal may be adjusted in amplitude at this point, at a later point, or at this and other points by an amplifier such as 104 to provide attenuation or amplification.
b. The processed signal is then filtered by a temporal filter used in conjunction with a vocalic detector 206 based on timing and vocal fold activation. If this additionally processed signal meets any pre-determined constraints, the signal is passed onward, else the signal is readjusted at the raw signal level or at any point post as necessary.
c. The additional processed signal is then modulated 208 using an ultrasonic carrier driven into saturation. This causes the temporal and voicing qualities for non-speech sound extraction to become accentuated. This also reduces the energy of intense non-speech sounds such as coughing.
d. The additionally processed and modulated speech signal may then be demodulated 210 by passing the signal through a diode rectifier adapted to increase the amplitude of consonant sounds about 15 dB. This allows for more precise automatic processing at a later stage.
e. The signal is thereby transformed into a linguistic signal in which much of the non-speech sound noise has been attenuated or eliminated 212/214.

When reference is made to amplification, amplification may occur by values greater or lesser than one, e.g. amplification may be by a factor of 0.1, 0.5, 1.5, 2, and so on.

### ADDITIONAL EXAMPLES

Six basic steps are to be utilized in a preferred embodiment of the invention. First, filtration techniques will remove chest sounds producing resonances at greater than 400 Hz. Second, a temporal filter will be used in conjunction with a vocalic detector. Third, the signal will be modulated unto an ultrasonic carrier. Fourth, carrier clipping will be employed. Fifth, the signal will be demodulated. Finally, any remaining NSS & NLSS pre-processing will be completed. In more detail, filtering will remove most of the energy in chest sounds (as measured directly from two subjects and consistent with the data in the literature). There are both digital and analog filtering processes and either is effective. Second, vocal fold vibrations will be detected and the direct vocal fold data removed. Note, tracking the formant frequencies is sufficient to determine periodicity. Vowels have formant structure (3 or 4) which transition to consonant sounds. This is a marker for speech and may separate most speech from speech “noise.” For example, real time filtering can be used to detect formants such as those in laughter. In the case of a sentence containing a laugh, there is vowel structure to the laugh. The vocalic detector functions to apply a series of narrow band filters which search for formants and their transitions. Identification of formants allows for an approximation to be made of the sentence boundary. Speech sound or phoneme boundaries are very difficult to detect since one sound blends into another and changes with the articulation context. This is termed co-articulation (Glas, 2003). The focus of the present invention concerns particularly sentence boundaries but the techniques herein may be modified for use with phoneme boundaries.

Sentences or phrases are based on breath support. Breathing supplies the subglottic pressure in the larynx for speech. Speech sounds in a syntax have a customary length or breath group. Using formant structure will identify most information in discourse. The fundamental frequency can also be helpful, but tracking it can be problematic.

Additional processing includes modulation onto an ultrasonic carrier, followed by demodulation. Gergory and Drysdale (1976) modulated speech by ultrasound, but intentionally drove the carrier into distortion, which would increase the energy in relatively weak speech sounds. Applying this principle in part, the modulated speech is then demodulated, resulting in an improved speech signal with compressed amplitude (in particular, weaker energy consonant sounds can be better detected). Note, vowel sounds naturally have almost 20 dB more power, which can be a problem for some threshold detection algorithms. The carrier overdrive reduces this dynamic between consonants and vowels to just a few dB.

Therefore, speech modulation will occur on an ultrasonic carrier, which will be driven to saturation or peak-clipped to better extract non-speech targets. When one sound (the modulator) is multiplied by another (the carrier), a process called amplitude modulation (AM) occurs, i.e. the product is the carrier plus and minus the modulator. Using an example of a modulator of 1 kHz and a carrier of 30 kHz the result would be a 29 and 31 kHz signal. Gregory and Drysdale (1976) multiplied speech by a carrier of 50 kHz. If they demodulated this product they would again have the exact same speech signal and a 50 kHz pure tone. However they added more energy to the carrier such that it was overdriven in their system and distorted. They then reintroduced the carrier by a process of heterodyning to demodulate the speech. When they did, they discovered that all the lower level components in the speech, such as high frequency consonants, were amplified. Distorting the carrier also produced distortion (intermodulation) products.

Using the tonal example of 1 kHz modulated by 30 kHz, the intermodulation products would be: 1+30/2+1−30/2 or 15.5+14.5 kHz (and odd harmonics). In addition there are harmonics of the intermodulation products: 2 (31)/2+2 (29)/2 or 31+29 kHz (and higher harmonics). Note, these intermodulation products are above the speech frequencies and can be easily filtered out.

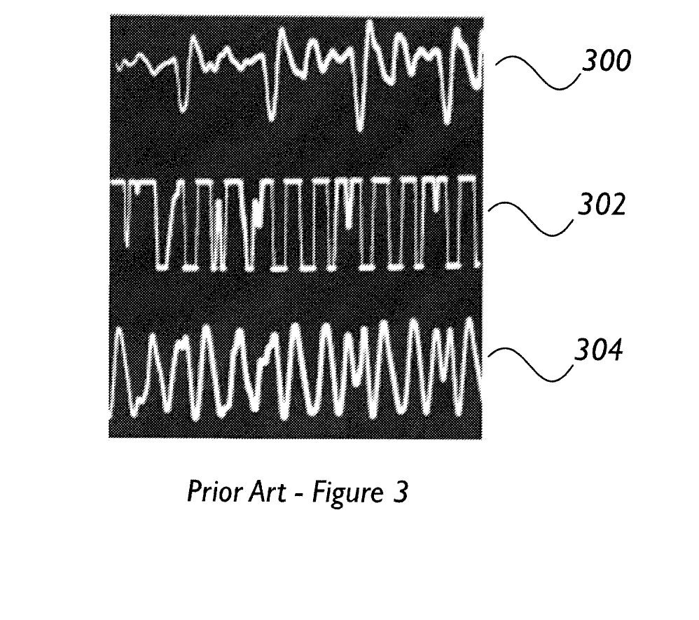

An example of the results of this technique is presented in FIG. 3.

With reference to FIG. 3, consonant sounds are naturally 20 dB lower in intensity than vowels. When the speech signal 300 is multiplied by a 50 kHz (AM) wave and driven into distortion (302), the signal is thereafter demodulated to produce signal 304. The demodulated speech now has almost equal amplitude for all speech sounds, making the speech more intelligible. Our technique utilizes an improved form of the Gregory and Drysdale function in conjunction with other speech processing methods. In a preferred embodiment, demodulation is accomplished by utilization of a diode as a signal rectifier.

EXEMPLARY INSTRUMENTATION: A means for processing algorithms may include a Capybara 320 Sound Engine with 2 DSP boards (Motorola DSP56309) and 192 MB memory, using Kyma 5.1 software (Symbolic Sound, Champaign, Ill.) may be used. The Kyma software is specialized for speech processing, including filtering, time/frequency/amplitude compression/expansion, and real-time spectral analysis and resynthesis. Also usable are a Tucker-Davis System 3, MATLAB, and LabView 8.0. Algorithms developed on the systems can be programmed in C and assembly and then downloaded to a DSP board containing an Analog Devices SHARC (21364) chip.

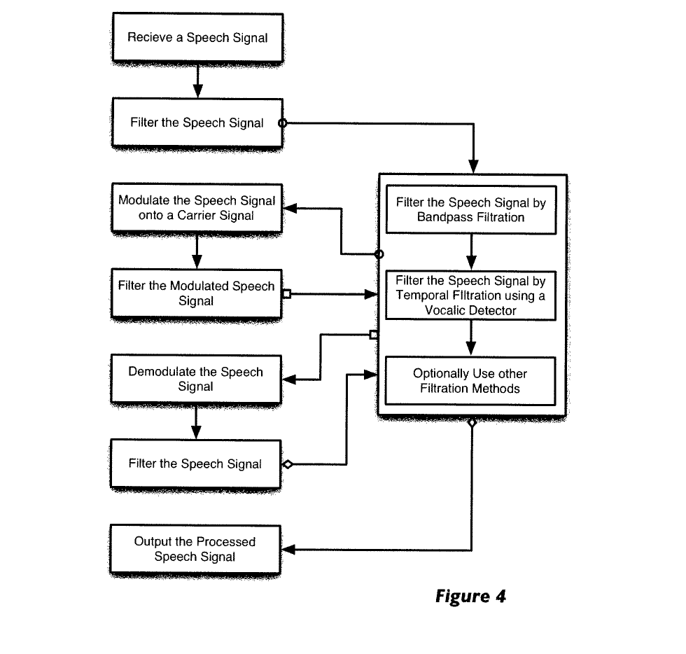

EXAMPLE: In one example, full AM is used. The carrier is set at 30 kHz and the speech and non-speech sounds [NSS] (laughter, coughing, grunting, sighing) are presented (See FIG. 4). Note, the NSS are broader in the modulated spectrum. Part of this is due to intensity (relative to normal speech) and part is due to the level of carrier overdrive used. Prior to demodulation, breathing sounds are eliminated by bandpass filtering (300-10,000 Hz).

NLSS such as “mhm”, “hmm”, “unhuh” and the like may be recognized by vocalic algorithms that will detect formant transitions. Additionally these sounds typically are present outside of the breath group for meaningful speech. As such, a temporal algorithm may be used to detect the NLSS and another parameter can be used to result in exclusion, i.e. the detector will recognize that there is no formant transition moving to a consonant position and too short a duration for a phrase group of speech sounds linked syntactically. These would generally appear temporally displaced. These specific examples have high frequency nasal resonance and aspirated components—each can also be tracked if needed. NLSS may be better detected after equalization by carrier peak clipped demodulation. The speech sample will be more intelligible, aiding in automatic speech processing.

EXAMPLE OF NSS EXTRACTION: After algorithm identification, a pointer will be placed at each temporal boundary and the intensity of the selected segment will be digitally zeroed. Boundary determinations in discourse are very difficult due to co-articulating, but this is not the case for many targets. Overlap of non-speech sound with discourse in a multiple talker sample may reduce intelligibility. One usable processor includes Analog Devices SHARC DSP Processor, specifically the ADSP-21369. This chip has the floating point processing power (about 2 gigaflops) to easily handle speech processing algorithms and a SIMD (Single Instruction Multiple Data) capability to streamline block data processing. The chip may be part of an integrated board, e.g. the ADSP-21369 EZ-KIT, which is a reference design board from Analog Devices can be used for preparing a prototype. This board also has 4 1M 32 bit buffers for block processing.

A key innovation in the present invention is that processing goes beyond current speech segmentation algorithms. The present invention employs carrier overdrive modulation. In addition, we utilize multiple sampling to process the signal at various stages. During the various phases of the processing, speech is processed to first remove lung, respiratory, and breathing sounds. Temporal and vocalic algorithms (T&VA) remove additional non-speech sounds. Modulation is performed and T&VA is once again performed. Demodulation equalizes the intensity of the signal providing a final speech signal ready for additional processing, such as an additional T&VA application. A summary of the process is shown in FIG. 4.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention. It is further known that other modifications may be made to the present invention, without departing the scope of the invention, as noted in the appended claims.

I claim:

1) A method for the removal and/or attenuation of non-speech and non-language speech sounds from a signal,
said method comprising the steps of:
a) generating
a carrier signal
in the ultrasonic bandwidth;
b) receiving said signal and filtering said signal, wherein said filtration includes filtering low-frequency signals and temporal filtration;
c) modulating said signal with said carrier signal wherein the modulation produces a peak-clipped signal;
d) filtering said peak-clipped signal;
e) demodulating said peak-clipped signal; and
f) filtering the demodulated peak-clipped signal.

2) The method of claim 1, wherein the demodulation is produced by use of a diode rectifier.

3) The method of claim 1, wherein the low frequency signals to be filtered are below 400 Hz.

4) A method of removing or attenuating non-speech and/or non-language speech sounds from a signal comprising the steps of:
a) providing said signal;
b) providing a carrier signal;
c) optionally amplifying the signal and/or the carrier signal;
d) filtering the signal non-temporally to provide a non-temporally filtered signal;
e) filtering the signal temporally to provide a non-temporally and temporally filtered signal;
f) modulating the signal onto the carrier signal to produce a modulated signal;
g) peak clipping the modulated signal;
h) optionally filtering the modulated signal;
i) demodulating the modulated signal to produce a demodulated signal thereby producing a final signal; and
j) optionally amplifying and/or filtering the demodulated signal to produce an additionally processed final signal.

5) The method of claim 4 wherein the modulator is adapted to produce full amplitude modulation containing a carrier and two sidebands.
